(19) United States
(12) Patent Application Publication
(10) Pub. No.: US 2013/0141806 A1
(43) Pub. Date: Jun. 6, 2013

(54) GLASS FILTER WITH ANTI-FRAGILITY LAYER AND LENS MODULE

(71) Applicant: CHUN-CHENG KO, New Taipei (TW)

(72) Inventor: CHUN-CHENG KO, New Taipei (TW)

(73) Assignee: HON HAI PRECISION INDUSTRY CO., LTD., Tu-Cheng (TW)

(21) Appl. No.: 13/431,992

(22) Filed: Mar. 28, 2012

(30) Foreign Application Priority Data
Dec. 1, 2011 (TW) 100144185

(51) Int. Cl. G02B 7/02; B32B 3/00

(52) U.S. Cl. 359/827; 428/189

(57) ABSTRACT

A glass filter assembly includes a circular glass substrate, an annular first anti-fragility layer, and a second anti-fragility layer. The circular glass substrate includes a first surface and a second surface opposite to the first surface. The first anti-fragility layer is concentrically adhered to the first surface. The outer diameter of the first anti-fragility layer is greater than or equal to the diameter of the circular glass substrate while the inner diameter of the first anti-fragility layer is smaller than the diameter of the circular glass substrate. The second anti-fragility layer is concentrically adhered to the second surface. The outer diameter of the second anti-fragility layer is greater than the diameter of the circular glass substrate while the inner diameter of the second anti-fragility layer is smaller than the diameter of the circular glass substrate.

### BACKGROUND

1. Technical Field

The present disclosure relates to glass filters and, particularly, to a glass filter with a protection film and a lens module using the glass filter.

2. Description of Related Art

Lens modules usually include a barrel, a glass filter received in the barrel, and at least one lens received in the barrel neighboring the glass filter. The glass filter is made of a colored or transparent glass substrate by grinding the glass substrate into a circular shape. Residual stress is distributed at the periphery of the glass filter after grinding, which makes the periphery of the glass filter fragile. When assembling the glass filter, the periphery of the glass filter usually collides with the inner surface of the barrel and may crack, generating glass particles. The glass particles fall onto the lens and influence the image quality of the lens modules.

Therefore, it is desirable to provide a glass filter and a lens module, which can overcome the limitations described.

### BRIEF DESCRIPTION OF THE DRAWINGS

FIG. 1 is an isometric schematic view of a lens module, according to an embodiment.

FIG. 2 is an isometric, exploded, schematic view of the lens module of FIG. 1

FIG. 3 is s a cross-sectional schematic view of the lens module of FIG. 1.

### DETAILED DESCRIPTION

Embodiments of the disclosure will be described in detail, with reference to the accompanying drawings.

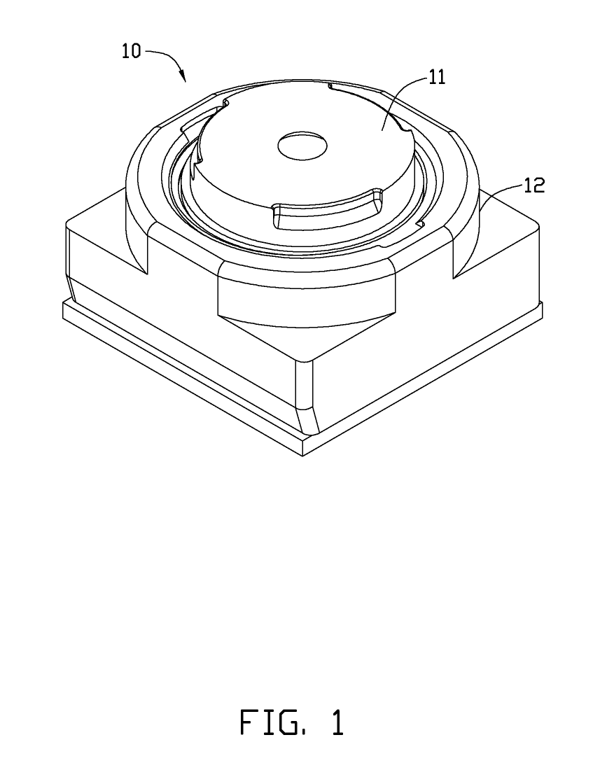

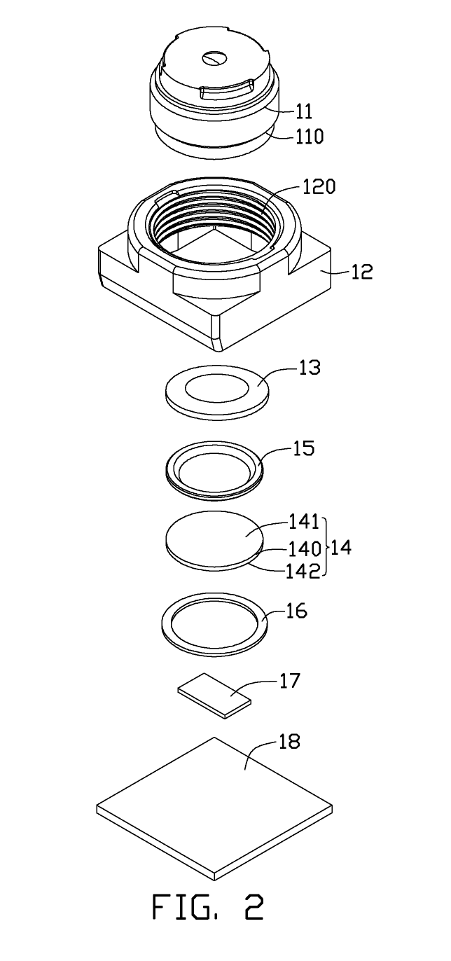

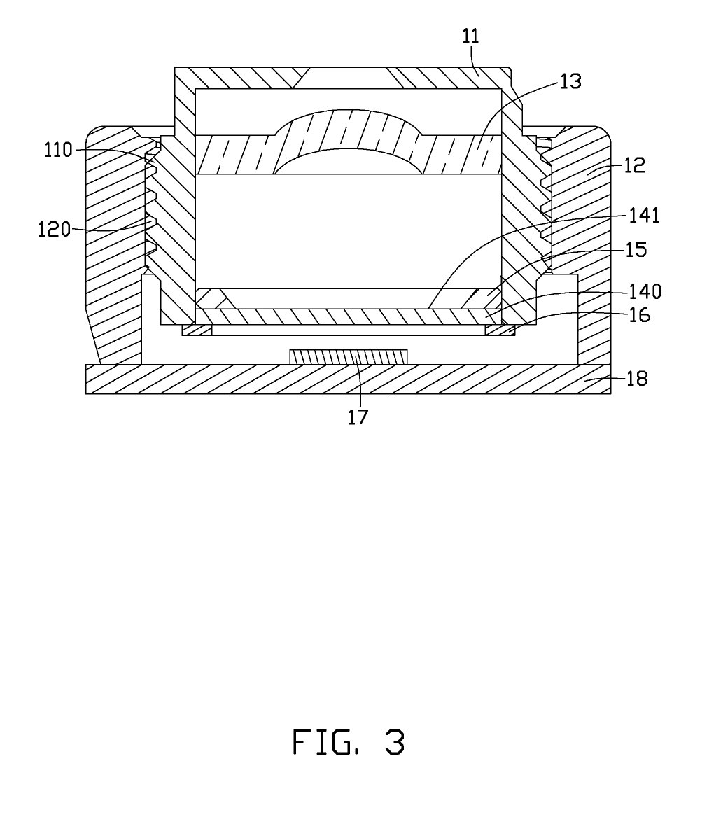

Referring to FIGS. 1-3, a lens module 10, according to an embodiment, is shown. The lens module 10 includes a barrel 11, a holder 12, a lens 13, a glass filter 14, a first anti-fragility layer 15, a second anti-fragility layer 16, an image sensor 17, and a printed circuit board (PCB) 18.

The lens 13 and the glass filter 14 are held in the barrel 11. In other embodiments, to obtain a desired optical performance, more lenses can be employed and are held in the barrel 11. The glass filter 14 can be an infrared cut filter or an infrared band pass filter and is positioned at the image-side end of the barrel 11.

The barrel 11 defines outer threads 110 and the holder 12 defines inner threads 120. The barrel 11 is threadedly screwed into and thereby held in the holder 12 via engagements between the outer threads 110 and the inner threads 120.

The glass filter 14 is made of a colored or transparent glass substrate 140 by grinding the glass substrate 140 into a circular shape. The glass substrate 140 includes a first surface 141 facing the object side of the barrel 11 and a second surface 142 facing the image side of the barrel 11. The diameter of the glass filter 14 is substantially equal to or slightly smaller than the inner diameter of the barrel 11, to allow the glass filter 14 being fittingly held in the barrel 11.

The first anti-fragility layer 15 is annular and concentrically adhered to the first surface 141. The outer diameter of the first anti-fragility layer 15 is essentially equal to or larger than the diameter of the first surface 141 while the inner diameter of the first anti-fragility layer 15 is smaller than the diameter of the first surface 141, thus preventing the outer periphery of the first surface 141 from cracking when the glass filter 14 is assembled into the barrel 11 and preventing the glass particles generated from the side surface of the glass filter 14 from falling into the lens 13. The upper limit of the outer diameter of the first anti-fragility layer 15 should be limited in an appropriate range to facilitate assembly of other optical elements of the lens module 10. The lower limit of the inner diameter of the first anti-fragility layer 15 should also be limited to an appropriate range to avoid adversely affecting the optical path of the lens module 10, e.g., changing the effective aperture of the lens module 10 or influencing the function of the glass filter 14.

The first anti-fragility layer 15 can be a layer of adhesive with a height greater than about 0.03 mm or an adhesive tape with a height greater than about 0.15 mm. It is noted that, the upper limit of the height of the first anti-fragility layer 15 should be limited to a suitable range to facilitate the assembly of other optical elements of the lens module 10.

The second anti-fragility layer 16 is annular and concentrically adhered to the second surface 142. The outer diameter of the second anti-fragility layer 16 is larger than the inner diameter of the barrel 11 while the inner diameter of the second anti-fragility layer 16 is smaller than the inner diameter of barrel 11 so as to prevent the outer periphery of the second surface 141 from cracking when the glass filter 14 is assembled into the barrel 11 and to prevent the glass particles generated from the side surface of the glass filter 14 from falling into the image sensor 17. The image sensor 17 is positioned beneath the second surface 142. It is noted, the upper limit of the outer diameter of the second anti-fragility layer 16 should be limited in an appropriate range to facilitate assembly of other optical elements of the lens module 10. The lower limit of the inner diameter of the second anti-fragility layer 16 should also be limited to an appropriate range to avoid adversely affecting the optical path of the lens module 10, e.g., changing the effective aperture of the lens module 10 or influencing the function of the glass filter 14.

The second anti-fragility layer 16 can be a layer of adhesive with a height greater than about 0.03 mm or an adhesive tape with a height greater than about 0.15 mm. Obviously, the upper limit of the height of the second anti-fragility layer 16 should be limited to a suitable range to facilitate of the assembly of other optical elements of the lens module 10.

The image sensor 17 is positioned on the PCB 18. The holder 12 is also positioned on the PCB 18 and houses the image sensor 17.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A glass filter assembly, comprising:
a circular glass substrate comprising a first surface and a second surface opposite to the first surface;
an annular first anti-fragility layer concentrically adhered to the first surface, an outer diameter of the first anti-fragility layer is greater than or equal to a diameter of the circular glass substrate while an inner diameter of the first anti-fragility layer is smaller than the diameter of the circular glass substrate; and
an annular second anti-fragility layer concentrically adhered to the second surface, an outer diameter of the second anti-fragility layer is greater than the diameter of the circular glass substrate while an inner diameter of the second anti-fragility layer is smaller than the diameter of the circular glass substrate.

2. The glass filter assembly of claim 1, wherein the first anti-fragility layer is a layer of adhesive with a height greater than about 0.03 mm or an adhesive tape with a height greater than about 0.15 mm.

3. The glass filter assembly of claim 1, wherein the second anti-fragility layer is a layer of adhesive with a height greater than about 0.03 mm or an adhesive tape with a height greater than about 0.15 mm.

4. A lens module, comprising:
a barrel;
a lens held in the barrel;
a circular glass substrate held in the barrel, the glass substrate comprising a first surface facing an object side of the barrel and a second surface opposite to the first surface;
an annular first anti-fragility layer concentrically adhered to the first surface and held in the barrel, an outer diameter of the first anti-fragility layer is greater than or equal to a diameter of the circular glass substrate while an inner diameter of the first anti-fragility layer is smaller than the diameter of the circular glass substrate; and
an annular second anti-fragility layer concentrically adhered to the second surface, an outer diameter of the second anti-fragility layer is greater than the diameter of the circular glass substrate while an inner diameter of the second anti-fragility layer is smaller than the diameter of the circular glass substrate.

5. The lens module of claim 4, wherein the first anti-fragility layer is a layer of adhesive with a height greater than about 0.03 mm or an adhesive tape with a height greater than about 0.15 mm.

6. The lens module of claim 4, wherein the second anti-fragility layer is a layer of adhesive with a height greater than about 0.03 mm or an adhesive tape with a height greater than about 0.15 mm.
